(19) United States
(12) Patent Application Publication
(10) Pub. No.: US 2024/0334517 A1
(43) Pub. Date: Oct. 3, 2024

(54) METHOD, APPARATUS AND COMPUTER PROGRAM

(71) Applicant: Nokia Technologies Oy, Espoo (FI)

(72) Inventors: Benoist Pierre SEBIRE, Tokyo (JP); Samuli Heikki TURTINEN, Oulu (FI)

(21) Appl. No.: 18/579,997

(22) PCT Filed: Aug. 13, 2021
(86) PCT No.: PCT/EP2021/072570

§ 371 Date: Jan. 17, 2024

(51) Int. Cl. H04W 76/15; H04L 5/00; H04W 72/51

(52) U.S. Cl. CPC H04W 76/15; H04L 5/0064; H04W 72/51

(57) ABSTRACT

There is provided an apparatus for a user equipment, the apparatus comprising means configured to perform, providing, to a network entity, a first message comprising an indication of whether the user equipment supports processing a plurality of streams in downlink data transmissions in parallel, and processing one or more streams of a received downlink data transmission that has been configured by the network entity according to the indication provided by the user equipment.

### FIELD

The present application relates to a method, apparatus, and computer program for a wireless communication system.

### BACKGROUND

A communication system may be a facility that enables communication sessions between two or more entities such as user terminals, base stations/access points and/or other nodes by providing carriers between the various entities involved in the communications path. A communication system may be provided, for example, by means of a communication network and one or more compatible communication devices. The communication sessions may comprise, for example, communication of data for carrying communications such as voice, electronic mail (email), text message, multimedia and/or content data and so on. Non-limiting examples of services provided comprise two-way or multi-way calls, data communication or multimedia services and access to a data network system, such as the Internet.

### SUMMARY

According to an aspect, there is provided an apparatus for a user equipment, the apparatus comprising means configured to perform: providing, to a network entity, a first message comprising an indication of whether the user equipment supports processing a plurality of streams in downlink data transmissions in parallel; and processing one or more streams of a received downlink data transmission that has been configured by the network entity according to the indication provided by the user equipment.

In an example, the means configured to perform the receiving comprises, in response to providing an indication that the user equipment supports processing a plurality of streams in parallel, receiving, from the network entity, the downlink data transmission that has been configured for processing a plurality of streams of downlink data transmissions in parallel at the user equipment.

In an example, the means configured to perform the receiving comprises, in response to providing an indication that the user equipment does not support processing a plurality of streams in parallel, receiving, from the network entity, the downlink data transmission that has not been configured for processing a plurality of streams of downlink data transmissions in parallel at the user equipment.

In an example, the means are configured to perform: receiving, from the network entity, a request for the indication of whether the user equipment supports processing a plurality of streams in parallel.

In an example, the indication comprises a first threshold value, the user equipment having support for processing a plurality of streams in parallel when a data rate is below the first threshold value, and the user equipment lacking support for processing a plurality of streams in parallel when the data rate is above the first threshold value.

In an example, the indication comprises a number of streams that can be processed in downlink data transmissions in parallel by the user equipment.

In an example, the indication comprises one of more second threshold values, each of the one or more second threshold values associated with a number of different streams that can be processed in downlink data transmissions in parallel by the user equipment,
such that when a data rate is below a respective threshold value of the one or more second threshold values, the user equipment will support the number of different streams that can be processed in downlink data transmissions in parallel by the user equipment associated with the respective threshold value.

In an example, the means are configured to perform: determining a change in the support for processing a plurality of streams in parallel, by the user equipment.

In an example, the means are configured to perform: in response to determining a change in the support, providing, to the network entity, a second message comprising an updated indication of the number of different streams that can be processed in downlink data transmissions in parallel by the user equipment.

In an example, the support for processing a plurality of streams in downlink data transmissions in parallel comprises a support for processing non-continuous packet data convergence protocol sequence numbers within a transport block.

In an example, the first message is a UECapabilityInformation message.

In an example, the second message is a UEAssistanceInformation message of radio resource control signalling.

In an example, the downlink data transmission is a 5G data transmission.

In an example, the plurality of streams comprises at least one of: a plurality of transport blocks, and a plurality of component carriers.

According to an aspect, there is provided an apparatus for a user equipment comprising: one or more processors, and memory storing instructions that, when executed by the one or more processors, cause the apparatus to perform: providing, to a network entity, a first message comprising an indication of whether the user equipment supports processing a plurality of streams in downlink data transmissions in parallel; and processing one or more streams of a received downlink data transmission that has been configured by the network entity according to the indication provided by the user equipment.

In an example, the apparatus being caused to perform the receiving comprises, in response to providing an indication that the user equipment supports processing a plurality of streams in parallel, receiving, from the network entity, the downlink data transmission that has been configured for processing a plurality of streams of downlink data transmissions in parallel at the user equipment.

In an example, the apparatus being caused to perform the receiving comprises, in response to providing an indication that the user equipment does not support processing a plurality of streams in parallel, receiving, from the network entity, the downlink data transmission that has not been configured for processing a plurality of streams of downlink data transmissions in parallel at the user equipment.

In an example, the apparatus is caused to perform: receiving, from the network entity, a request for the indication of whether the user equipment supports processing a plurality of streams in parallel.

In an example, the indication comprises a first threshold value, the user equipment having support for processing a plurality of streams in parallel when a data rate is below the first threshold value, and the user equipment lacking support for processing a plurality of streams in parallel when the data rate is above the first threshold value.

In an example, the indication comprises a number of streams that can be processed in downlink data transmissions in parallel by the user equipment.

In an example, the indication comprises one of more second threshold values, each of the one or more second threshold values associated with a number of different streams that can be processed in downlink data transmissions in parallel by the user equipment, such that when a data rate is below a respective threshold value of the one or more second threshold values, the user equipment will support the number of different streams that can be processed in downlink data transmissions in parallel by the user equipment associated with the respective threshold value.

In an example, the apparatus is caused to perform: determining a change in the support for processing a plurality of streams in parallel, by the user equipment.

In an example, the apparatus is caused to perform: in response to determining a change in the support, providing, to the network entity, a second message comprising an updated indication of the number of different streams that can be processed in downlink data transmissions in parallel by the user equipment.

In an example, the support for processing a plurality of streams in downlink data transmissions in parallel comprises a support for processing non-continuous packet data convergence protocol sequence numbers within a transport block.

In an example, the first message is a UECapabilityInformation message.

In an example, the second message is a UEAssistanceInformation message of radio resource control signalling.

In an example, the downlink data transmission is a 5G data transmission.

In an example, the plurality of streams comprises at least one of: a plurality of transport blocks, and a plurality of component carriers.

According to an aspect, there is provided a method performed by a user equipment, the method comprising: providing, to a network entity, a first message comprising an indication of whether the user equipment supports processing a plurality of streams in downlink data transmissions in parallel; and processing one or more streams of a received downlink data transmission that has been configured by the network entity according to the indication provided by the user equipment.

In an example, the receiving comprises, in response to providing an indication that the user equipment supports processing a plurality of streams in parallel, receiving, from the network entity, the downlink data transmission that has been configured for processing a plurality of streams of downlink data transmissions in parallel at the user equipment.

In an example, the receiving comprises, in response to providing an indication that the user equipment does not support processing a plurality of streams in parallel, receiving, from the network entity, the downlink data transmission that has not been configured for processing a plurality of streams of downlink data transmissions in parallel at the user equipment.

In an example, the method comprises: receiving, from the network entity, a request for the indication of whether the user equipment supports processing a plurality of streams in parallel.

In an example, the indication comprises a first threshold value, the user equipment having support for processing a plurality of streams in parallel when a data rate is below the first threshold value, and the user equipment lacking support for processing a plurality of streams in parallel when the data rate is above the first threshold value.

In an example, the indication comprises a number of streams that can be processed in downlink data transmissions in parallel by the user equipment.

In an example, the indication comprises one of more second threshold values, each of the one or more second threshold values associated with a number of different streams that can be processed in downlink data transmissions in parallel by the user equipment, such that when a data rate is below a respective threshold value of the one or more second threshold values, the user equipment will support the number of different streams that can be processed in downlink data transmissions in parallel by the user equipment associated with the respective threshold value.

In an example, the method comprises: determining a change in the support for processing a plurality of streams in parallel, by the user equipment.

In an example, the method comprises: in response to determining a change in the support, providing, to the network entity, a second message comprising an updated indication of the number of different streams that can be processed in downlink data transmissions in parallel by the user equipment.

In an example, the support for processing a plurality of streams in downlink data transmissions in parallel comprises a support for processing non-continuous packet data convergence protocol sequence numbers within a transport block.

In an example, the first message is a UECapabilityInformation message.

In an example, the second message is a UEAssistanceInformation message of radio resource control signalling.

In an example, the downlink data transmission is a 5G data transmission.

In an example, the plurality of streams comprises at least one of: a plurality of transport blocks, and a plurality of component carriers.

According to an aspect, there is provided an apparatus for a network entity, the apparatus comprising means configured to perform: receiving, from a network entity, a first message comprising an indication of whether the user equipment supports processing a plurality of streams in downlink data transmissions in parallel; configuring one or more streams for a downlink data transmission to the user equipment according to the received indication; and providing, to the user equipment, the downlink data transmission.

In an example, the means configured to perform configuring the one or more streams comprises: mapping one or more data units onto the one or more streams according to the received indication.

In an example, the means are configured to perform: providing, to the user equipment, a request for the indication of whether the user equipment supports processing a plurality of streams in parallel.

In an example, the indication comprises a first threshold value, the user equipment having support for processing a plurality of streams in downlink data transmissions in parallel when a data rate is below the first threshold value, and the user equipment lacking the support for processing a plurality of streams in downlink data transmissions in parallel when the data rate is above the first threshold value.

In an example, the indication comprises a number of different streams that can be processed in parallel by the user equipment, Np.

In an example, the means configured to perform configuring one or more transport blocks comprises filling the one or more streams scheduled for parallel transmissions such that data units are alternated within Np transport blocks on Np component carriers in parallel, before allocating data units on another component carrier, wherein Np is the number of different streams that can be processed in parallel by the user equipment.

In an example, the data units are packet data convergence protocol data units.

In an example, the indication comprises one of more second threshold values, each of the one or more second threshold values associated with a number of streams that can be processed in downlink data transmissions in parallel by the user equipment, such that when a data rate is below a respective threshold value of the one or more second threshold values, the user equipment will support the number of different streams that can be processed in downlink data transmissions in parallel by the user equipment associated with the respective threshold value.

In an example, the means are configured to perform: receiving, from the network entity, a second message comprising an updated indication of the number of different streams that can be processed in downlink data transmissions in parallel by the user equipment.

In an example, the support for processing a plurality of streams in downlink data transmissions in parallel comprises a support for processing non-continuous packet data convergence protocol sequence numbers in a downlink transport block.

In an example, the first message is a UECapabilityInformation message.

In an example, the second message is a UEAssistanceInformation message of radio resource control signalling.

In an example, the downlink data transmission is a 5G data transmission.

In an example, the plurality of streams comprises at least one of: a plurality of transport blocks, and a plurality of component carriers.

According to an aspect, there is provided an apparatus for a network entity comprising: one or more processors, and memory storing instructions that, when executed by the one or more processors, cause the apparatus to perform: receiving, from a network entity, a first message comprising an indication of whether the user equipment supports processing a plurality of streams in downlink data transmissions in parallel; configuring one or more streams for a downlink data transmission to the user equipment according to the received indication; and providing, to the user equipment, the downlink data transmission.

In an example, the apparatus being caused to perform configuring the one or more streams comprises: mapping one or more data units onto the one or more streams according to the received indication.

In an example, the apparatus is caused to perform: providing, to the user equipment, a request for the indication of whether the user equipment supports processing a plurality of streams in parallel.

In an example, the indication comprises a first threshold value, the user equipment having support for processing a plurality of streams in downlink data transmissions in parallel when a data rate is below the first threshold value, and the user equipment lacking the support for processing a plurality of streams in downlink data transmissions in parallel when the data rate is above the first threshold value.

In an example, the indication comprises a number of different streams that can be processed in parallel by the user equipment, Np.

In an example, the apparatus being caused to perform configuring one or more transport blocks comprises filling the one or more streams scheduled for parallel transmissions such that data units are alternated within Np transport blocks on Np component carriers in parallel, before allocating data units on another component carrier, wherein Np is the number of different streams that can be processed in parallel by the user equipment.

In an example, the data units are packet data convergence protocol data units.

In an example, the indication comprises one of more second threshold values, each of the one or more second threshold values associated with a number of streams that can be processed in downlink data transmissions in parallel by the user equipment, such that when a data rate is below a respective threshold value of the one or more second threshold values, the user equipment will support the number of different streams that can be processed in downlink data transmissions in parallel by the user equipment associated with the respective threshold value.

In an example, the apparatus is caused to perform: receiving, from the network entity, a second message comprising an updated indication of the number of different streams that can be processed in downlink data transmissions in parallel by the user equipment.

In an example, the support for processing a plurality of streams in downlink data transmissions in parallel comprises a support for processing non-continuous packet data convergence protocol sequence numbers in a downlink transport block.

In an example, the first message is a UECapabilityInformation message.

In an example, the second message is a UEAssistanceInformation message of radio resource control signalling.

In an example, the downlink data transmission is a 5G data transmission.

In an example, the plurality of streams comprises at least one of: a plurality of transport blocks, and a plurality of component carriers.

According to an aspect, there is provided a method performed by a network entity, the method comprising: receiving, from a network entity, a first message comprising an indication of whether the user equipment supports processing a plurality of streams in downlink data transmissions in parallel; configuring one or more streams for a downlink data transmission to the user equipment according to the received indication; and providing, to the user equipment, the downlink data transmission.

In an example, the configuring the one or more streams comprises: mapping one or more data units onto the one or more streams according to the received indication.

In an example, the method comprises: providing, to the user equipment, a request for the indication of whether the user equipment supports processing a plurality of streams in parallel.

In an example, the indication comprises a first threshold value, the user equipment having support for processing a plurality of streams in downlink data transmissions in parallel when a data rate is below the first threshold value, and the user equipment lacking the support for processing a plurality of streams in downlink data transmissions in parallel when the data rate is above the first threshold value.

In an example, the indication comprises a number of different streams that can be processed in parallel by the user equipment, Np.

In an example, the configuring one or more transport blocks comprises filling the one or more streams scheduled for parallel transmissions such that data units are alternated within Np transport blocks on Np component carriers in parallel, before allocating data units on another component carrier, wherein Np is the number of different streams that can be processed in parallel by the user equipment.

In an example, the data units are packet data convergence protocol data units.

In an example, the indication comprises one of more second threshold values, each of the one or more second threshold values associated with a number of streams that can be processed in downlink data transmissions in parallel by the user equipment, such that when a data rate is below a respective threshold value of the one or more second threshold values, the user equipment will support the number of different streams that can be processed in downlink data transmissions in parallel by the user equipment associated with the respective threshold value.

In an example, the method comprises: receiving, from the network entity, a second message comprising an updated indication of the number of different streams that can be processed in downlink data transmissions in parallel by the user equipment.

In an example, the support for processing a plurality of streams in downlink data transmissions in parallel comprises a support for processing non-continuous packet data convergence protocol sequence numbers in a downlink transport block.

In an example, the first message is a UECapabilityInformation message.

In an example, the second message is a UEAssistanceInformation message of radio resource control signalling.

In an example, the downlink data transmission is a 5G data transmission.

In an example, the plurality of streams comprises at least one of: a plurality of transport blocks, and a plurality of component carriers.

According to an aspect, there is provided a computer program comprising computer executable instructions which when run on one or more processors perform: providing, to a network entity, a first message comprising an indication of whether the user equipment supports processing a plurality of streams in downlink data transmissions in parallel; and processing one or more streams of a received downlink data transmission that has been configured by the network entity according to the indication provided by the user equipment.

According to an aspect, there is provided a computer program comprising computer executable instructions which when run on one or more processors perform: receiving, from a network entity, a first message comprising an indication of whether the user equipment supports processing a plurality of streams in downlink data transmissions in parallel; configuring one or more streams for a downlink data transmission to the user equipment according to the received indication; and providing, to the user equipment, the downlink data transmission.

A computer product stored on a medium may cause an apparatus to perform the methods as described herein.

An electronic device may comprise apparatus as described herein.

In the above, various aspects have been described. It should be appreciated that further aspects may be provided by the combination of any two or more of the various aspects described above.

Various other aspects and further embodiments are also described in the following detailed description and in the attached claims.

According to some aspects, there is provided the subject matter of the independent claims. Some further aspects are defined in the dependent claims. The embodiments that do not fall under the scope of the claims are to be interpreted as examples useful for understanding the disclosure.

### List of Abbreviations

AF: Application Function
AMF: Access Management Function
AN: Access Network
BS: Base Station
CC: Component Carrier
CN: Core Network
DL: Downlink
eNB: eNodeB
gNB: gNodeB
LTE: Long Term Evolution
NEF: Network Exposure Function
NG-RAN: Next Generation Radio Access Network
NGAP: Next Generation Application Protocol
NF: Network Function
NR: New Radio
NRF: Network Repository Function
NW: Network
MS: Mobile Station
PCF Policy Control Function
PDCP: Packet Data Convergence Protocol
PDU: Protocol Data Unit
PLMN: Public Land Mobile Network
RAN: Radio Access Network
RF: Radio Frequency
RLF: Radio Link Failure
RRC: Radio Resource Control
SDU: Service Data Unit
SMF: Session Management Function
SN: Sequence Number
UE: User Equipment
UDR: Unified Data Repository
UDM: Unified Data Management
UL: Uplink
UPF: User Plane Function
3GPP: 3^{rd} Generation Partnership Project
5G: 5^{th} Generation
5GC: 5G Core network
5G-AN: 5G Radio Access Network
5GS: 5G System

### DESCRIPTION OF FIGURES

Embodiments will now be described, by way of example only, with reference to the accompanying Figures in which:

FIG. 1 shows a schematic representation of a 5G system;

FIG. 2 shows a schematic representation of a control apparatus;

FIG. 3 shows a schematic representation of a terminal;

FIG. 4a shows a schematic representation of the format of a PDCP PDU with a 12 bit PDCP SN;

FIG. 4b shows a schematic representation of the format of a PDCP PDU with an 18 bit PDCP SN;

FIG. 5 shows an example signalling diagram between a user equipment and a network entity;

FIG. 6 shows another example method flow diagram performed by a user equipment;

FIG. 7 shows an example method flow diagram performed by a network entity; and

FIG. 8 shows a schematic representation of a non-volatile memory medium storing instructions which when executed by a processor allow a processor to perform one or more of the steps of the method of FIGS. 6 and 7.

### DETAILED DESCRIPTION

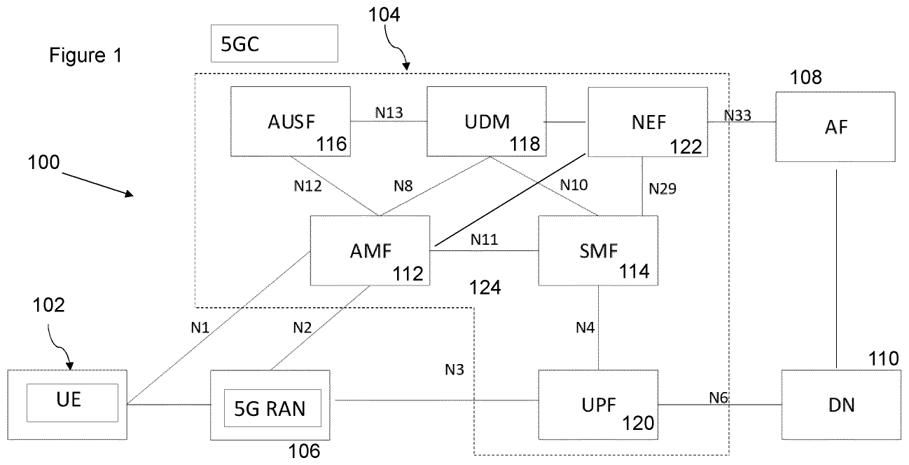

Before explaining in detail some examples of the present disclosure, certain general principles of a wireless communication system and mobile communication devices are briefly explained with reference to FIGS. 1 to 3 to assist in understanding the technology underlying the described examples.

In a wireless communication system 100, such as that shown in FIG. 1, mobile communication devices/terminals or user apparatuses, and/or user equipments (UE), and/or machine-type communication devices 102 are provided wireless access via at least one base station (not shown) or similar wireless transmitting and/or receiving node or point. A communication device is provided with an appropriate signal receiving and transmitting apparatus for enabling communications, for example enabling access to a communication network or communications directly with other devices. The communication device may access a carrier provided by a station or access point, and transmit and/or receive communications on the carrier.

In the following certain examples are explained with reference to mobile communication devices capable of communication via a wireless cellular system and mobile communication systems serving such mobile communication devices. Before explaining in detail the examples of disclose, certain general principles of a wireless communication system, access systems thereof, and mobile communication devices are briefly explained with reference to FIGS. 1, 2 and 3 to assist in understanding the technology underlying the described examples.

FIG. 1 shows a schematic representation of a 5G system (5GS) 100. The 5GS may comprise a device 102 such as user equipment or terminal, a 5G access network (5G-RAN) 106, a 5G core network (5GC) 104, one or more network functions (NF), one or more application function (AF) 108 and one or more data networks (DN) 110.

The 5G-RAN 106 may comprise one or more gNodeB (gNB) distributed unit (DU) functions connected to one or more gNodeB (gNB) centralized unit (CU) functions. In a 5G-RAN architecture, the baseband unit functionality is split into two functional units including the DU, which is responsible for L1 and L2 scheduling functions, and the CU which is responsible for higher L2 and L3 scheduling functions.

The 5GC 104 may comprise an access management function (AMF) 112, a session management function (SMF) 114, an authentication server function (AUSF) 116, a user data management (UDM) 118, a user plane function (UPF) 120, a network exposure function (NEF) 122 and/or other NFs. Some of the examples as shown below may be applicable to 3GPP 5G standards. However, some examples may also be applicable to 4G, 3G, beyond 5G, 6G, etc., and other 3GPP standards.

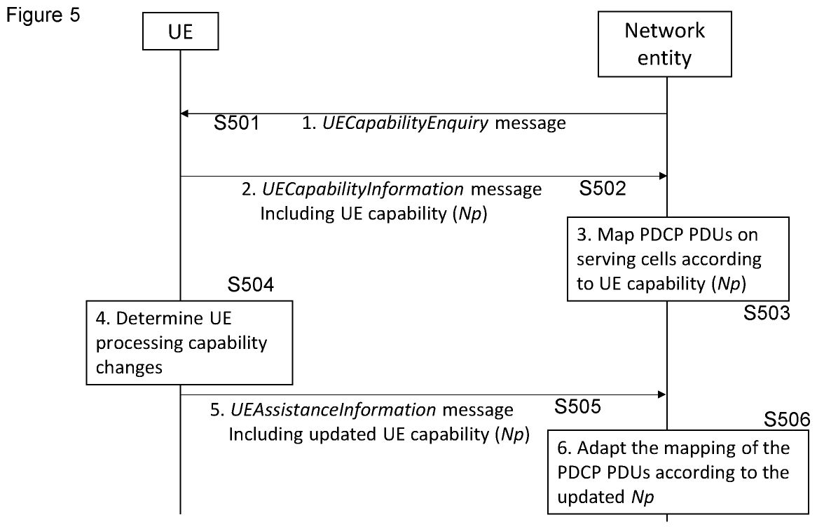

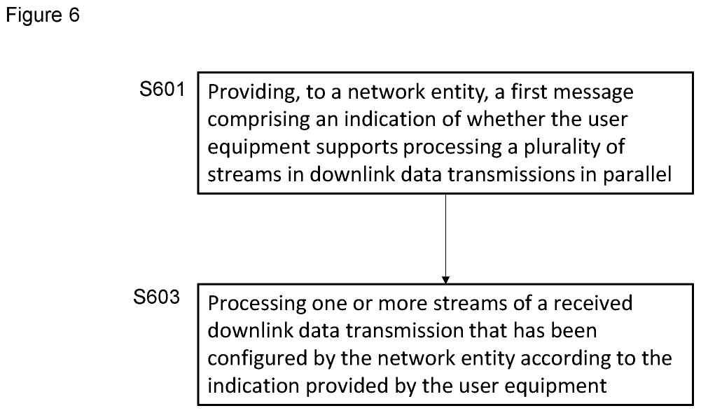

In a communication system, such as that shown in FIG. 1, mobile communication devices/terminals or user apparatuses, and/or user equipments (UE), and/or machine-type communication devices are provided with wireless access via at least one base station or similar wireless transmitting and/or receiving node or point. The terminal is provided with an appropriate signal receiving and transmitting apparatus for enabling communications, for example enabling access to a communication network or communications directly with other devices. The communication device may access a carrier provided by a station or access point, and transmit and/or receive communications on the carrier. Terminal 102 is also depicted in FIG. 5, with labels 10, 16, 19, 20A, 20B. Terminal 102 is also depicted in FIG. 6 with label 601, for example. The terminal 102 may use communications services. Two or more terminals may use the same communications services. In other examples, two or more terminals may have different services from each other.

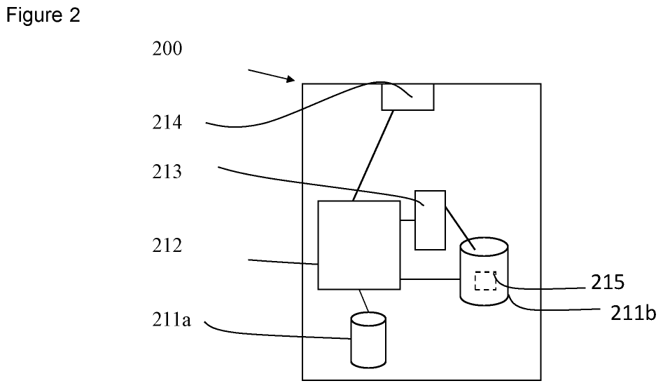

FIG. 2 illustrates an example of a control apparatus 200 for controlling a function of the 5G-AN or the 5GC as illustrated on FIG. 1. The control apparatus may comprise at least one random access memory (RAM) 211a, at least on read only memory (ROM) 211b, at least one processor 212, 213 and an input/output interface 214. The at least one processor 212, 213 may be coupled to the RAM 211a and the ROM 211b. The at least one processor 212, 213 may be configured to execute an appropriate software code 215. The software code 215 may for example allow to perform one or more steps to perform one or more of the present aspects. The software code 215 may be stored in the ROM 211b. The control apparatus 200 may be interconnected with another control apparatus 200 controlling another function of the 5G-AN or the 5GC. In some examples, each function of the 5G-AN or the 5GC comprises a control apparatus 200. In alternative examples, two or more functions of the 5G-AN or the 5GC may share a control apparatus.

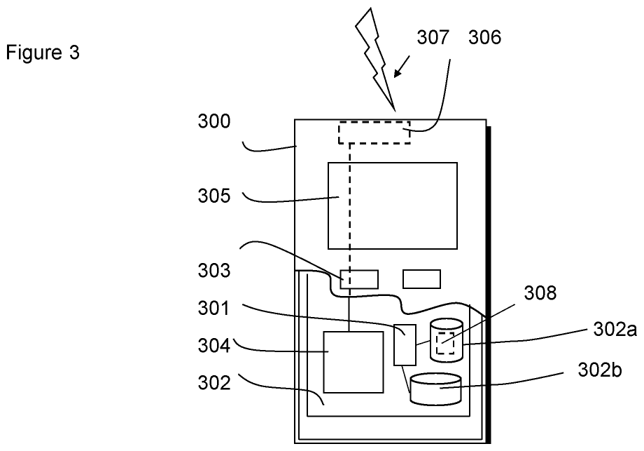

FIG. 3 illustrates an example of a terminal 300, such as the terminal illustrated on FIG. 1. The terminal 300 may be provided by any device capable of sending and receiving radio signals. Non-limiting examples comprise a user equipment, a mobile station (MS) or mobile device such as a mobile phone or what is known as a ‘smart phone’, a computer provided with a wireless interface card or other wireless interface facility (e.g., USB dongle), a personal data assistant (PDA) or a tablet provided with wireless communication capabilities, a machine-type communications (MTC) device, a Cellular Internet of things (CIoT) device or any combinations of these or the like. The terminal 300 may provide, for example, communication of data for carrying communications. The communications may be one or more of voice, electronic mail (email), text message, multimedia, data, machine data and so on.

The terminal 300 may receive signals over an air or radio interface 307 via appropriate apparatus for receiving and may transmit signals via appropriate apparatus for transmitting radio signals. In FIG. 3 transceiver apparatus is designated schematically by block 306. The transceiver apparatus 306 may be provided for example by means of a radio part and associated antenna arrangement. The antenna arrangement may be arranged internally or externally to the mobile device.

The terminal 300 may be provided with at least one processor 301, at least one memory ROM 302a, at least one RAM 302b and other possible components 303 for use in software and hardware aided execution of tasks it is designed to perform, including control of access to and communications with access systems and other communication devices. The at least one processor 301 is coupled to the RAM 302a and the ROM 302a. The at least one processor 301 may be configured to execute an appropriate software code 308. The software code 308 may for example allow to perform one or more of the present aspects. The software code 308 may be stored in the ROM 302a.

The processor, storage and other relevant control apparatus may be provided on an appropriate circuit board and/or in chipsets. This feature is denoted by reference 304. The device may optionally have a user interface such as keypad 305, touch sensitive screen or pad, combinations thereof or the like. Optionally one or more of a display, a speaker and a microphone may be provided depending on the type of the device.

Some of the following examples are related to 5G communications, also known as New Radio (NR). NR has evolved LTE radio protocols to allow for parallel processing to take place at the user equipment side. For example, by pushing real time operations as close as possible to the physical layer, upper layers can process data in a non-real time fashion and apply parallel processing instead. It has been identified that not all chipsets in UEs benefit from the parallel processing. In some examples, UEs are not capable of parallel processing.

When parallel processing is performed at the network side and, for example, 2 carriers are used in the downlink, then the packet data convergence protocol sequence numbers (PDCP SN) on the two carriers may alternate. This is exemplified in Table 1 below:

TABLE 1
Example configuration for PDCP SNs in transport blocks.

| Np | 2 | 2 | 2 | 2 |
|---|---|---|---|---|
| TB | 1 | 2 | 3 | 4 |
| CC1 | 1, 3, 5 | 7, 9, 11 | 13, 15 | . . . |
| CC2 | 2, 4, 6 | 8, 10, 12 | 14 | . . . |

As seen in Table 1, for transport block 1 (TB1), component carrier 1 (CC1) carries sequence numbers 1, 3 and 5. Component carrier 2 (CC2) then carries sequence numbers 2, 4, 6. For TB2, CC1 carries SNs 7, 9 and 11. CC2 carries SNs 8, 10, 12. For TB3, CC1 carries SNs 13 and 15. CC2 carries SN 14. In this way, the two component carriers carry alternate PDCP SNs.

Sequence numbers are included in many different types of data frames, packets, etc, such as PDCP protocol data units. Sequence numbers may be used to determine whether packets/data units are being processed and/or delivered in order, and to determine whether packets/data units are missing. Furthermore, sequence numbers may allow for packet duplication, and may also serve as an input to security (ciphering and integrity protection). Some of the following examples are related to PDCP PDUs and PDCP SNs. It should be understood that the examples are also applicable to other protocols.

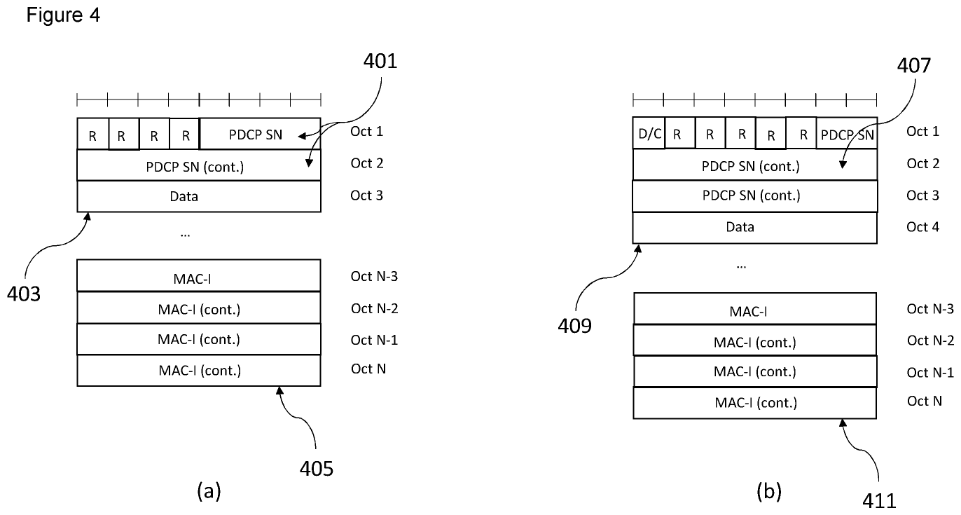

FIG. 4a shows a PDCP data PDU format for a signalling radio bearer (SRB). Each block in the PDU represents 1 bit. The PDCP sequence number (SN) 401 is made up of 12 bits, spread over octet 1 and octet 2. The data block 403 is made up of 8 bits. There is also provided a message authentication code-integrity (MAC-1) 405 field. The MAC-I makes up 4 bytes. The MAC-I is a special field added by the PDCP layer to each RRC message for the purpose of integrity protection. When the PDCP PDU is for a data radio bearer (DRB) then the MAC-I fields are optional.

FIG. 4b shows a PDCP data PDU with an 18 bit PDCP SN. The PDCP PDU of FIG. 4b is suitable for DRBs.

The PDCP SN can have a length of 12 or 18 bits. The length of the PDCP SN may be configured by upper layers, such as, for example, RRC. Each block in the PDU represents 1 bit. The PDCP sequence number (SN) 407 is made up of 18 bits, spread over octets 1 to 3. The data block 409 is made up of 8 bits. There is also provided a message authentication code-integrity (MAC-1) 411 field. The MAC-I 411 makes up 4 bytes. The MAC-I field 411 is optional.

When the example configuration of Table 1 is used by the network, or similar, for a downlink data transmission to the user equipment, it has been identified that some user equipments cannot process such a large amount of data at an acceptable rate. In this situation, a user equipment may declare a radio link failure (RLF).

Radio link failure (RLF) is a common phenomenon in all radio access technologies which can occur when a radio channel signal strength is too weak to continue. RLF is a local event detected by UE. The UE may inform the network of the RLF. It can be difficult for the UE to recover due to low signal. Hence, RLF is often dealt with locally by the UE. In some instances, an RLF can lead to a reestablishment of a connection between the UE and the network. Therefore, it is important for network efficiency that RLFs are minimised.

One or more of the examples discussed below aim to address these identified problems.

In examples, there is provided a mechanism which allows a user equipment to declare, to the network, its support for processing component carriers in parallel. The user equipment may also determine a change in the support, and provide an update of the support to the network. This will be discussed in more detail below.

FIG. 5 shows an example signalling diagram between a user equipment and a network entity.

At S501, the network entity provides an enquiry message to the UE. The network is enquiring about a support for processing a plurality of streams (data streams) in downlink data transmissions in parallel at the UE. In this example, the enquiry message is a ‘UECapabilityEnquiry’ message. In other examples, another suitable message can be used. In an example, the plurality of streams may comprise a plurality of protocol data units (PDUs), or service data units (SDUs). In this example, the UE may have support for processing a plurality of PDUs/SDUs in parallel. In an example, the plurality of streams may comprise a plurality of transport blocks (TBs). In this example, the UE may have support for processing a plurality of TBs in parallel. In another example, the plurality of streams may comprise a plurality of component carriers (CCs). In this example, the UE may have support for processing a plurality of CCs in parallel.

In these examples, it should be understood that the terms ‘streams’ and ‘data streams’ can be used interchangeably.

At S502, the UE provides a message to the network entity, the message comprising the support of the UE. The message may indicate that the UE does support processing a plurality of streams in parallel. The message may indicate that the UE does not support processing a plurality of streams in parallel. In this example, the message is a ‘UECapabilityInformation’ message. In other examples, other suitable messages can be used.

The message may also indicate a number of streams that the UE can process in parallel.

The number of parallel processes/data streams that can be supported concurrently by the UE may be referred to as ‘Np’.

In another example, the UE may indicate its support by indicating a number of transport blocks (TBs) which can be processed in parallel to carry PDCP protocol data units (PDUs). Furthermore, the UE may indicate on to which PDCP PDUs to alternate sequence numbers.

In another example, the UE may indicate its support by indicating whether the UE supports non-continuous PDCP SNs in DL transport blocks.

In another example, the UE may indicate its support by indicating how many SN gaps the UE could tolerate within a transport block.

At S503, the network entity configures a downlink (DL) data transmission for the UE, according to the indication provided by the UE. When the indication from the UE shows that the UE supports processing a plurality of streams in parallel, then the configuration of the DL data transmission will be such that the UE can process the data using parallel processing. When the indication from the UE shows that the UE does not support processing a plurality of streams in parallel, then the configuration of the DL data transmission will be such that the UE can process the data without using parallel processing.

Table 3 illustrated below shows an example configuration for a downlink data transmission that may be configured by the network. The top row of Table 3 shows an Np value, wherein the Np value represents a number of streams that can be processed by the UE. An Np value of 2 or above means that the UE can support processing a plurality of streams in parallel (two in this example). An Np value of 1 means that the UE cannot support processing a plurality of streams in parallel. As seen in the example configuration of FIG. 3, when the Np value is 2 then the CCs are configured with alternate SNs. When the Np value is 1 then the CCs are configured with continuous SNs. For example, a UE may process data with SN 1 first. In this example, CC1 has the data with SN 1. Following this, the UE will process SN 2, which is provided in CC2. In this way, the UE can process both CC1 and CC2 in parallel.

TABLE 2
Another example configuration for PDCP SNs in transport blocks.

| Np | 2 | 2 | 1 | 1 | 1 |
|---|---|---|---|---|---|
| TB | 1 | 2 | 3 | 5 | 6 |
| CC1 | 1, 3, 5 | 7, 9, 11 | 13, 14 | 17, 18 | 21 |
| CC2 | 2, 4, 6 | 8, 10, 12 | 15, 16 | 19, 20 | 22, 23 |

The configuring by the network entity may comprise mapping one or more data units onto one or more transport blocks according to the received indication.

The configuring by the network may comprise filling one or more transport blocks, scheduled for a parallel transmission, such that data units are alternated within Np transport blocks on Np component carriers in parallel. The network entity may then allocate data units on another component carrier. Np being the number of parallel processes (streams) that can be supported by the UE.

The configuring by the network entity may comprise mapping PDCP PDUs onto serving cells according to the indication provided by the UE, and/or the Np value.

At 8504, the UE determines whether there has been a change in the support at the UE. The support for processing a plurality of streams in parallel at the UE may change over time, for example, depending on how the UEs internal processing capabilities vary over time. For example, various tasks at the UE can reduce the processing power available for processing the radio protocols including at least one of: positioning calculation, multicast/broadcast services (MBS) reception, or tasks required by the application layer. These tasks are shown as examples only. It should be various other tasks or factors could affect the UE's ability to perform parallel processing.

For example, a change in the support at the UE may comprise changing from a lack of support for processing a plurality of streams in parallel to a support for processing a plurality of streams in parallel.

For example, a change in the support at the UE may comprise changing from a support for processing a plurality of streams in parallel to a lack of support for processing a plurality of streams in parallel.

For example, a change in the support at the UE may comprise changing from a first Np value (indicating a number of concurrent streams that can be processed) to a second Np value, wherein the first and second Np values are different.

At S505, in response to the UE determining a change in the support for processing a plurality of streams in parallel, the UE provides an update message to the network entity. For example, the update message may indicate that the now supports parallel processing, when the UE did not before. In another example, the update message may indicate that the UE no longer supports parallel processing, when the UE did previously support it. In another example, the update message may comprise an updated Np value. The Np value may be updated based on the determination by the UE.

In this example, the update message is a ‘UEAssistanceInformation’ message. In other examples, any other suitable message can be used. The ‘UEAssistanceInformation’ message is defined in radio resource control (RRC).

At S506, the network entity configures the DL data transmission for the UE, according to the updated indication provided by the UE. In an example, the network may re-configure the DL data transmission for the UE, according to the updated indication provided by the UE. In another example, the network entity may configure a new DL data transmission for the UE, according to the updated indication provided by the UE. The process of the configuration/reconfiguration is similar to the process described in S503.

Alternatively, or additionally, the above mechanisms in FIG. 5 may be implemented with respect to DL data rate thresholds. In an example, the UE may indicate that it could allow parallel processing in DL with a data rate below a threshold, but the UE would not tolerate parallel processing with a higher data rate above the threshold. For example, the threshold may be 1 gigabyte per second (Gbps). The indication may be interpreted by the network as meaning that the UE can support processing of a plurality of streams in parallel when the data rate is below 1 Gbps. The threshold value is given as an example only, in other examples the threshold is lower or higher than 1 Gbps.

In an example, the UE may indicate multiple data rate thresholds which equate to different levels of parallel processing. The different levels of processing may be the number of streams that the UE can support concurrently, as described above. For example, the UE may indicate a first threshold value for a data rate, wherein the UE supports a first number of concurrent streams when the data rate is below the first threshold. The UE may also indicate a second threshold value for a data rate, wherein the UE supports a second number of concurrent streams when the data rate is higher than the first threshold and lower than the second threshold. For example, the first threshold is 1 Gbps and the second threshold is 2 Gbps. The UE indicates that it can support, for example, 5 concurrent streams if the data rate is lower than the first threshold of 1 Gbps, while the UE can support, for example, 2 concurrent streams if the data rate is lower than the second threshold of 2 Gbps. It should be understood that the values used are as examples only to aid in the understanding of the features.

Table 3 illustrated below shows an example configuration for a DL transmission for a UE, wherein the UE has indicated support for parallel processing of streams. In this example, the UE has indicated support for two concurrent streams (i.e. Np=2). In some examples, the number of CCs used may not be constrained by the Np value, and these two elements can be decoupled. In this example, with an Np of 2, 4 component carriers are configured, with the PDCP SNs of PDCP PDUs in transport blocks shown below:

TABLE 3
Another example configuration for PDCP SNs in transport blocks.

| Np | 2 | 2 | 2 |
|---|---|---|---|
| TB | 1 | 2 | 3 |
| CC1 | 1, 3, 5 | 11, 13 | . . . |
| CC2 | 2, 4, 6 | 12, 14 | . . . |
| CC3 | 7, 9 | 15, 17 | . . . |
| CC4 | 8, 10 | 16, 18, 19 | . . . |

As seen in Table 3, for transport block 1 (TB1), component carrier 1 (CC1) carries sequence numbers 1, 3 and 5. Component carrier 2 (CC2) then carries sequence numbers 2, 4, 6. Component carrier 3 (CC3) then carries sequence numbers 7 and 9. Component carrier 4 (CC4) then carries sequence numbers 8 and 10. For TB2, CC1 carries SNs 11 and 13. CC2 carries SNs 12 and 14. CC3 carries SNs 15 and 17. CC4 carries SNs 16, 18 and 19.

In this way, the different component carriers (CC1 to CC4) carry alternate PDCP SNs. The alternating manner of the SNs in the TBs means that the UE can process them in parallel. Without parallel processing, a processor of the UE has to take one PDU from each CC, or buffer a whole CC before starting the next CC. Therefore, without parallel processing, this increases the time taken to process data. It should be understood that the configuration of Table 3 is shown as an example only to aid in the understanding.

One or more of the examples discussed above means that the UE may express its preference/requirement for parallel processing of DL data transmissions which allows the network to determine whether to use parallel processing at all or whether to gap the DL data rate to a sufficient level such that the transmission does not cause issues for the UE. In this way, radio link failures at the UE will be reduced/will no longer occur.

FIG. 6 shows an example method flow performed by an apparatus. The apparatus may be for a terminal or user equipment. The apparatus may be provided in a terminal or user equipment.

In S601, the method comprises providing, to a network entity, a first message comprising an indication of whether the user equipment supports processing a plurality of streams in downlink data transmissions in parallel.

In S603, the method comprises processing one or more streams of a received downlink data transmission that has been configured by the network entity according to the indication provided by the user equipment.

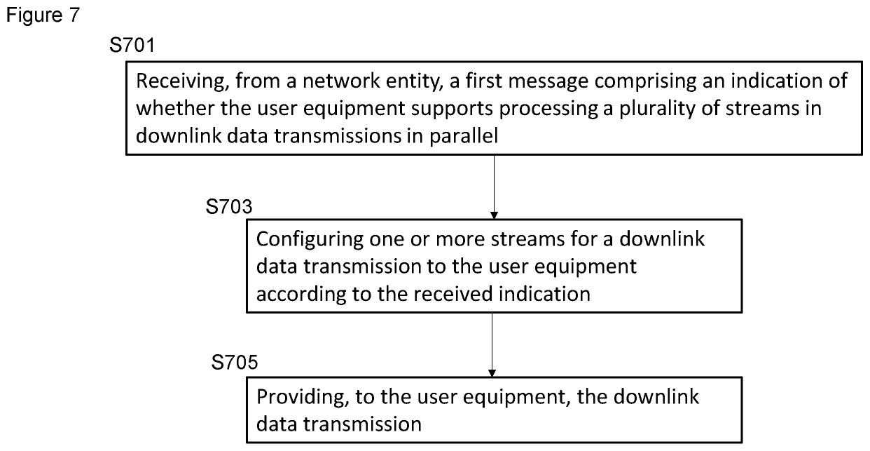

FIG. 7 shows an example method flow performed by an apparatus. The apparatus may be for a network entity. The apparatus may be provided in a network entity. The network entity may be, for example, a core network function.

In S701, the method comprises receiving, from a network entity, a first message comprising an indication of whether the user equipment supports processing a plurality of streams in downlink data transmissions in parallel.

In S703, the method comprises configuring one or more streams for a downlink data transmission to the user equipment according to the received indication.

In S705, the method comprises providing, to the user equipment, the downlink data transmission.

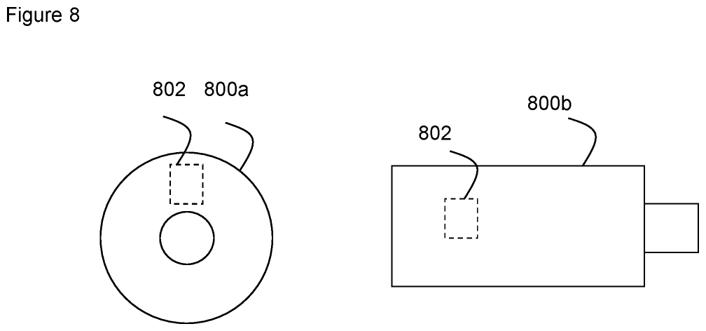

FIG. 8 shows a schematic representation of non-volatile memory media 800a (e.g. computer disc (CD) or digital versatile disc (DVD)) and 800b (e.g. universal serial bus (USB) memory stick) storing instructions and/or parameters 802 which when executed by a processor allow the processor to perform one or more of the steps of the methods of FIG. 6 or FIG. 7.

In should be understood that in the above signalling diagram of FIG. 5, there may be variations of the steps that take place. In some examples, some of the steps shown may be omitted. In some examples, some of steps may take place in a different order than shown in the Figures.

It is noted that while the above describes example embodiments, there are several variations and modifications which may be made to the disclosed solution without departing from the scope of the present invention.

The examples may thus vary within the scope of the attached claims. In general, some embodiments may be implemented in hardware or special purpose circuits, software, logic or any combination thereof. For example, some aspects may be implemented in hardware, while other aspects may be implemented in firmware or software which may be executed by a controller, microprocessor or other computing device, although embodiments are not limited thereto. While various embodiments may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The examples may be implemented by computer software stored in a memory and executable by at least one data processor of the involved entities or by hardware, or by a combination of software and hardware. Further in this regard it should be noted that any procedures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi core processor architecture, as non-limiting examples.

Alternatively, or additionally some examples may be implemented using circuitry. The circuitry may be configured to perform one or more of the functions and/or method steps previously described. That circuitry may be provided in the base station and/or in the communications device.

As used in this application, the term “circuitry” may refer to one or more or all of the following:
(a) hardware-only circuit implementations (such as implementations in only analogue and/or digital circuitry);
(b) combinations of hardware circuits and software, such as:
   (i) a combination of analogue and/or digital hardware circuit(s) with software/firmware and
   (ii) any portions of hardware processor(s) with software (including digital signal processor(s)), software, and memory(ies) that work together to cause an apparatus, such as the communications device or base station to perform the various functions previously described; and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example integrated device.

The foregoing description has provided by way of exemplary and non-limiting examples a full and informative description of some embodiments. However, various modifications and adaptations may become apparent to those skilled in the relevant arts in view of the foregoing description, when read in conjunction with the accompanying drawings and the appended claims. However, all such and similar modifications of the teachings will still fall within the scope as defined in the appended claims.

1. An apparatus for a user equipment, the apparatus comprising: one or more processors, and memory storing instructions that, when executed by the one or more processors, cause the apparatus to perform:
providing, to a network entity, a first message comprising an indication of whether the user equipment supports processing a plurality of streams in downlink data transmissions in parallel; and
processing one or more streams of a received downlink data transmission that has been configured by the network entity according to the indication provided by the user equipment.

2. The apparatus according to claim 1, wherein the indication comprises a first threshold value, the user equipment having support for processing a plurality of streams in parallel when a data rate is below the first threshold value, and the user equipment lacking support for processing a plurality of streams in parallel when the data rate is above the first threshold value.

3. The apparatus according to claim 1, wherein the indication comprises a number of streams that can be processed in downlink data transmissions in parallel by the user equipment.

4. The apparatus according to claim 3, wherein the indication comprises one of more second threshold values, each of the one or more second threshold values associated with a number of different streams that can be processed in downlink data transmissions in parallel by the user equipment,
such that when a data rate is below a respective threshold value of the one or more second threshold values, the user equipment will support the number of different streams that can be processed in downlink data transmissions in parallel by the user equipment associated with the respective threshold value.

5. The apparatus according to claim 1, caused to perform:
determining a change in the support for processing a plurality of streams in parallel, by the user equipment.

6. The apparatus according to claim 5, caused to perform:
in response to determining a change in the support, providing, to the network entity, a second message comprising an updated indication of the number of different streams that can be processed in downlink data transmissions in parallel by the user equipment.

7. The apparatus according to claim 1, wherein the support for processing a plurality of streams in downlink data transmissions in parallel comprises a support for processing non-continuous packet data convergence protocol sequence numbers within a transport block.

8. The apparatus according to claim 1, wherein the first message is a UECapabilityInformation message.

9. The apparatus according to claim 1, wherein the second message is a UEAssistanceInformation message of radio resource control signalling.

10. The apparatus according to claim 1, wherein the downlink data transmission is a 5G data transmission.

11. The apparatus according to claim 1, wherein the plurality of streams comprises at least one of: a plurality of transport blocks, and a plurality of component carriers.

12. An apparatus for a network entity, the apparatus comprising: one or more processors, and memory storing instructions that, when executed by the one or more processors, cause the apparatus: to perform:
receiving, from a user equipment, a first message comprising an indication of whether the user equipment supports processing a plurality of streams in downlink data transmissions in parallel;
configuring one or more streams for a downlink data transmission to the user equipment according to the received indication; and
providing, to the user equipment, the downlink data transmission.

13. The apparatus according to claim 12, wherein the configuring the one or more streams comprises: mapping one or more data units onto the one or more streams according to the received indication.

14. The apparatus according to claim 12, wherein the indication comprises a first threshold value, the user equipment having support for processing a plurality of streams in downlink data transmissions in parallel when a data rate is below the first threshold value, and the user equipment lacking the support for processing a plurality of streams in downlink data transmissions in parallel when the data rate is above the first threshold value.

15. The apparatus according to claim 12, wherein the indication comprises a number of different streams that can be processed in parallel by the user equipment, Np.

16. The apparatus according to claim 15, wherein the configuring one or more transport blocks comprises filling the one or more streams scheduled for parallel transmissions such that data units are alternated within Np transport blocks on Np component carriers in parallel, before allocating data units on another component carrier, wherein Np is the number of different streams that can be processed in parallel by the user equipment.

17. The apparatus according to claim 15, wherein the indication comprises one of more second threshold values, each of the one or more second threshold values associated with a number of streams that can be processed in downlink data transmissions in parallel by the user equipment,
such that when a data rate is below a respective threshold value of the one or more second threshold values, the user equipment will support the number of different streams that can be processed in downlink data transmissions in parallel by the user equipment associated with the respective threshold value.

18. The apparatus according to claim 12, caused to perform:
receiving, from the network entity, a second message comprising an updated indication of the number of different streams that can be processed in downlink data transmissions in parallel by the user equipment.

19. The apparatus according to claim 12, wherein the support for processing a plurality of streams in downlink data transmissions in parallel comprises a support for processing non-continuous packet data convergence protocol sequence numbers in a downlink transport block.

20-23. (canceled)

24. A method performed by a user equipment, the method comprising:
providing, to a network entity, a first message comprising an indication of whether the user equipment supports processing a plurality of streams in downlink data transmissions in parallel; and
processing one or more streams of a received downlink data transmission that has been configured by the network entity according to the indication provided by the user equipment.

25. (canceled)
